(19) United States
(12) Patent Application Publication
(10) Pub. No.: US 2026/0273360 A1
(43) Pub. Date: Sep. 17, 2026

(54) GRASPABLE APPARATUS WITH DEFORMATION SENSOR ASSEMBLY AND METHODS OF USING THE SAME

(71) Applicant: Toyota Research Institute, Inc., Los Altos, CA (US)

(72) Inventors: Edwardo Martinez, Fremont, CA (US); Alexander Alspach, Somerville, MA (US); Andrew M. Beaulieu, Arlington, MA (US); Erin Anne McColl, Los Gatos, CA (US); Haeyeon Lee, Redwood City, CA (US); Jonathan Yao, San Jose, CA (US)

(73) Assignees: Toyota Research Institute, Inc., Los Altos, CA (US); Toyota Jidosha Kabushiki Kaisha, Aichi-ken (JP)

(21) Appl. No.: 19/081,313

(22) Filed: Mar. 17, 2025

(51) Int. Cl. A63B 60/46; A63B 24/00; A63B 60/08; B25G 1/02; G01B 11/16; G01L 1/24

(52) U.S. Cl. CPC A63B 60/46; A63B 24/0062; A63B 60/08; B25G 1/02; G01B 11/16; G01L 1/24; A63B 2060/464; A63B 2220/56; A63B 2220/805; A63B 2220/833

(57) ABSTRACT

A graspable apparatus, system, and method for grasping sensing include a grip portion including a first end, a second end, and a body between the first end and the second end, a deformation sensor assembly embedded in the body. The deformation sensor assembly includes a housing defining a cavity therein, the housing including a deformable surface configured to be engaged with a user during grasping, a plurality of objects disposed within the cavity, and a vision sensor arranged in the cavity, the vision sensor operable to monitor real-time positions of the objects.

### TECHNICAL FIELD

Embodiments described herein generally relate to contact sensors and, more particularly, to deformable contact sensors embedded in graspable apparatuses.

### BACKGROUND

People often encounter difficulty with a fine-controlling force while manipulating sports gear items and mechanical tools. Accordingly, there is a need to embed force or pressure sensors in sports gear items and mechanical tools to help address the challenges by providing real-time feedback that enables people to dynamically adjust their grasping and manipulations.

### SUMMARY

In one embodiment, a graspable apparatus for grasping sensing includes a grip portion including a first end, a second end, and a body between the first end and the second end, and a deformation sensor assembly embedded in the body. The deformation sensor assembly includes a housing defining a cavity therein, the housing including a deformable surface configured to be engaged with a user during grasping, a plurality of objects disposed within the cavity, and a vision sensor arranged in the cavity, the vision sensor operable to monitor real-time positions of the plurality of objects.

In a second embodiment, a graspable assembly for grasping sensing includes an active portion configured to interact with a target, a grip portion including a first end, a second end, a body between the first end and the second end, a shaft portion mechanically connecting the active portion and the grip portion, and a deformation sensor assembly embedded in the body. The deformation sensor assembly includes a housing defining a cavity therein, the housing including a deformable surface configured to be engaged with a user during grasping, a plurality of objects disposed within the cavity, and a vision sensor arranged in the cavity, the vision sensor operable to monitor real-time positions of the plurality of objects.

In a third embodiment, a method to use a graspable apparatus for grasping sensing includes monitoring, using a vision sensor arranged in a cavity of a deformation sensor assembly, real-time positions of a plurality of objects disposed within the cavity, determining whether at least one of the plurality of objects is displaced based on the real-time positions of the plurality of objects, in response to determining that the at least one of the plurality of objects is displaced, determining a grasping pressure of a deformable surface of the deformation sensor assembly at least partially based on a displacement of the at least one of the plurality of objects. The deformation sensor assembly is embedded in a grip portion of the graspable apparatus. The deformation sensor assembly includes a housing, the plurality of objects, and the vision sensor. The housing defines the cavity therein, the housing including the deformable surface configured to be engaged with a user during grasping.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and example in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an example deformation sensor assembly including objects, according to one or more embodiments described and illustrated herein;

FIG. 2A schematically depicts a perspective view of an example graspable assembly as a sports gear item, according to one or more embodiments described and illustrated herein;

FIG. 2B schematically depicts a perspective view of an example graspable assembly as a mechanical tool, according to one or more embodiments described and illustrated herein;

FIG. 3 depicts non-limiting components of an example deformation sensor assembly, according to one or more embodiments shown and described herein; and

FIG. 4 is a flow chart depicting an example process of determining a grasping pressure using an example deformation sensor assembly, according to one or more embodiments described and illustrated herein.

### DETAILED DESCRIPTION

Many sports gear items and mechanical tools require a user to grasp the sports gear items and the mechanical tools at grips to use them. To use these sports gear items and mechanical tools, skillful grasping is important in optimizing performance, reducing misuse, and enhancing the overall user experience. In sports, the amount of pressure applied to the grip directly influences accuracy, control, and endurance. For example, in activities like tennis, golf, or shooting, excessive grip pressure can lead to muscle fatigue, reduced precision, and even repetitive strain injuries such as tennis elbow or golfer’s elbow. Conversely, insufficient grip pressure may compromise control, leading to poor performance or an increased risk of misusage. Similarly, in mechanical tools like drills, hammers, or screwdrivers, improper grip pressure can reduce tool efficiency, increase user fatigue, and result in workplace injuries. Therefore, there is a need for real-time monitoring of grasping pressure to achieve the desired balance between control and comfort, and enhance performance.

Existing technologies do not incorporate systems to monitor or provide feedback on grip pressure and lack dynamic feedback mechanisms that inform users about their grip strength in real time. While some specialized devices may measure overall force or torque, these do not offer localized data on the specific pressure applied at the grip points. Furthermore, existing wearable devices, like fitness trackers and smartwatches, measure general metrics such as heart rate or movement, but fall short in providing detailed feedback on grip dynamics. This gap in current technology limits the ability of athletes, workers, and users to make data-driven adjustments that could improve performance, prevent injury, and optimize tool usage.

The disclosed apparatus and systems can integrate pressure sensors into the grip portion of sports gear items and mechanical tools for users to receive real-time feedback on their grasping pressure. In sports, this technology can help athletes fine-tune their grip to improve performance, ensuring they apply the desired amount of force for increased accuracy and control while reducing fatigue. The disclosed apparatus and systems can also serve as a valuable coaching tool, providing data-driven insights to refine techniques and track progress over time. In the realm of mechanical tools, pressure sensors can reduce workplace misuse by alerting users when excessive force is applied, thereby reducing the risk of strain injuries. Additionally, the disclosed apparatus and systems can improve productivity by ensuring consistent, efficient grip pressure for tasks that require precision, like assembly work or delicate repairs.

Embodiments of the present disclosure are directed to graspable apparatuses including a grip portion including a first end, a second end, and a body between the first end and the second end. The grip portion may be included in a sports gear item or a mechanical tool. A deformation sensor assembly is embedded in the grip portion of the graspable apparatus. The deformation sensor assembly includes a deformable surface configured to be engaged with a user during grasping. The deformation sensor assembly detects grasping pressure applied to the sports gear item or the mechanical tool in real time and provides feedback to the user. The stiffness of the deformable surface may have substantially the same stiffness compared with a grip surface material of the sports gear item or the mechanical tool such that the grasping experience of the disclosed embodiments is comparable to the sports gear items and/or the mechanical tools of the same kind. The stiffness of the deformable surface may be tuned by adjusting the internal pressure of the deformation sensor assembly.

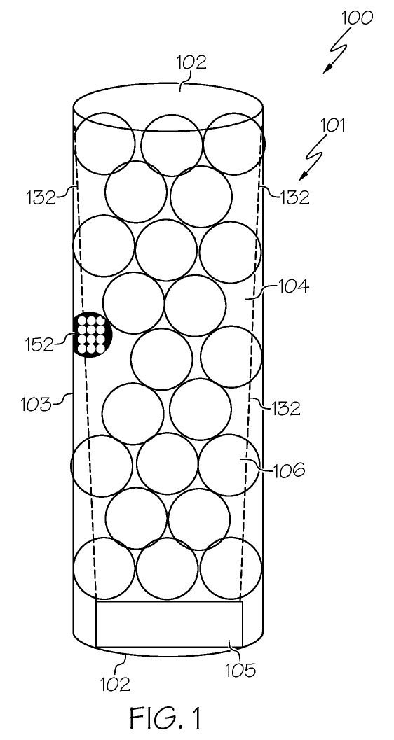

Referring now to FIG. 1, an example deformation sensor assembly 100 is schematically illustrated in a side view. The example deformation sensor assembly 100 generally includes a housing 101. The housing 101 includes a deformable surface 103. The housing 101 includes opposing end surfaces 102. The deformable surface 103 may be flexible and/or deformable. Each of the opposing end surfaces 102 may be rigid and/or undeformable. The deformable surface 103 is coupled to the opposing end surfaces 102 to define a cavity 104. The cavity 104 includes a plurality of objects 106. In some embodiments, the objects 106 in the cavity 104 may provide support to the deformable surface 103 such that the deformable surface 103 may form a cylindrical shape as shown in FIG. 1. It should be appreciated that any suitable shape of the deformable surface 103 may be utilized in other embodiments. In some embodiments, the cavity 104 may further include a medium (e.g., gas, liquid, or solid) in space not occupied by the objects 106. The deformation sensor assembly 100 may include one or more position sensors, such as vision sensors, proximity sensors, of the like, that are configured to determine positions or connection patterns of the objects 106, which are further used to determine a displacement and deformation of the deformable surface 103.

In some embodiments, a position sensor is positioned within the housing 101, such as a vision sensor 105 mechanically coupled to an inner surface of one of the opposing end surfaces 102. In some embodiments, such as the embodiment illustrated in FIG. 1, the housing 101 is cylindrical. The vision sensor 105 is mechanically coupled to an inner surface of one cylindrical end of the housing 101. It should be appreciated that in some other embodiments, one or more of the position sensors are placed outside of the housing 101. When an external force is applied to the deformable surface 103 causing a deformation of the deformable surface 103, for example during interaction with a user through grasping, the objects 106 move and shapes of the objects 106 change in a synchronized manner, leading to a change of the positions or connection patterns of the objects 106. The vision sensor 105 captures the positions and connection patterns of the objects 106 in real time. The deformation sensor assembly 100 uses the real-time object position and movement to determine the deformation and displacement of the deformable surface 103. In some embodiments, the deformation sensor assembly 100 further includes a light source 152. The light source 152 is located within the housing 101 in embodiments, such as mechanically coupled to an inner surface of one of the opposing end surfaces 102, an inner surface of the deformable surface 103, or any place within the cavity 104. The light source emits light to illuminate the positions of the objects 106.

In some embodiments, the deformable surface 103 is flexible and includes a deformable membrane. In some embodiments, the deformable membrane includes latex, silicone rubber, thermoplastic elastomers, polyurethane, ethylene vinyl acetate, gel materials, foamed polymers, hydrogels, or any other suitable material, such as a suitably thin, non-porous, rubber-like material. The deformable surface 103 may be transparent, diaphanous, or opaque. In some embodiments, the deformable surface 103 includes an optional filter layer. The filter layer is configured to aid the vision sensor 105 in detecting deformation of the deformable surface 103. In some embodiments, the filter layer reduces glare or improper reflections of one or more optical signals emitted by the vision sensor 105 and/or the light source 152. In some embodiments, the filter layer scatters one or more optical signals emitted by the vision sensor 105. The filter layer may be an additional layer secured to a bottom surface of the deformable membrane, or it may be a coating and/or pattern applied to the bottom surface of the deformable surface 103.

In embodiments, the opposing end surfaces 102 may be rigid and/or undeformable. The opposing end surfaces 102 may provide structure support to the deformable surface 103, allowing the deformable surface 103 to deform and adapt to manipulate one or more objects while being supported by a stable, rigid base. One of the opposing end surfaces 102 may be flat as illustrated in FIG. 1 or shaped to accommodate specific design needs. In some embodiments, one of the opposing end surfaces 102 includes a polymer (e.g., acrylic, polycarbonate, polyethylene terephthalate, nylon), a metal alloy (e.g., aluminum, stainless steel), a composite material (e.g., fiberglass, carbon fiber), a ceramic (e.g., alumina), or any suitable material. In some embodiments, one of the opposing end surfaces 102 includes structures to allow deformation sensor assembly 100 to be mechanically coupled to external structures and devices. It should be appreciated that, in some embodiments, one of the opposing end surfaces 102 may be made of flexible materials, and a mechanical interaction of one of the opposing end surfaces 102 with an external structure may further provide sufficient support through interactions between one of the opposing end surfaces 102 and the external structure.

In embodiments, the objects 106 are filled within the cavity 104. The objects 106 may be transparent, transparent with light diffusion, semi-transparent, semi-opaque, opaque with light permeation, or opaque. In some embodiments, the objects 106 includes material of latex, silicone, optical-grade acrylic, clear plastics, clear glass, low-tint glass, clear polycarbonate, frosted glass, diffusing acrylic, textured plastics, milk glass, translucent plastics, opaque plastics with embedded particles, partially frosted acrylic, thick frosted glass, tinted or colored plastics, thick opaque plastics, dense ceramics, or any materials suitable for the application. The objects 106 may be cast or three-dimensional (3D) printed. The objects 106 may be doped with salts, minerals, or other materials. The objects 106 may be arranged in a close-packed pattern, with each object 106 in contact with one or more neighbor objects 106.

In some embodiments, the objects 106 include more than one color. The objects 106 may be distributed randomly or patterned in terms of color. In one embodiment, the objects 106 may include a mixed-color pattern. In yet another embodiment, the objects 106 may be arranged in a partially order color pattern and a partially random color pattern. The objects 106 may be arranged in other patterns, such as a gradient pattern (e.g., the color distributed with the color transition from one side to another side, from top to bottom, or from outer to center), a striped pattern (e.g., horizontal, vertical, or diagonal stripes in varying colors).

In some embodiments, the objects 106 are in the shape of a spherical shape, a rectangular prism shape, a hexagonal prism shape, a pyramid shape, or a combination thereof. The objects 106 may be in different sizes or a uniform size. The objects 106 may be elastic or rigid. The objects 106 may have a Young’s Modulus of between around 0.001 GPa to around 10 GPa. For example, the objects 106 may be made of silicone having Young’s Modulus of around 0.001 GPa to 0.1 GPa, rubber having Young’s Modulus of around 0.01 GPa to around 1 GPa, or polymer, having Young’s Modulus of around 2 GPa to around 5 GPa.

In some embodiments, the cavity 104 further includes medium in the space not occupied by the objects 106. The medium may be in gas phase, in liquid phase, or in solid phase. In some embodiments, the objects 106 are configured to move according to a deformation of the deformable surface 103 in a synchronized manner. In some embodiments, the objects 106 may be at elastic equilibrium such that the objects 106 may move back to the original positions upon a removal of the external force, such as grasping by the user, and a consequent diminishment of the deformation of the deformable surface 103. In some embodiments, the objects 106 may not return to the original positions after the removal of the external force.

In some embodiments, the deformability of the deformable surface 103 are tuned/modified by changing the material of the deformable surface 103, the material of the objects 106, and/or the pressure within the cavity 104. By using a softer material (e.g., soft silicone), the deformable surface 103 may be more easily deformed. Similarly, lowering the pressure within the cavity 104 may also cause the deformable surface 103 to more easily deform. In some embodiments, the cavity 104 is inflated to a pressure of 0.20 psi to 0.30 psi. In some embodiments, the deformable surface 103 features varying touch sensitivity due to varying spatial resolution and/or depth resolution. As used herein, spatial resolution may refer, for example, to how many pixels a vision sensor has. The number of pixels may range from 1 (e.g., a sensor that simply detects contact with a target object) to thousands or millions (e.g., a dense tactile sensor provided by a time-of-flight sensor having thousands of pixels) or any suitable number.

Still referring to FIG. 1, in some embodiments, the vision sensor 105 is, without limitation, a camera, a red green blue (RGB) sensor, RBG-depth (RGBD) sensor, a time-of-flight sensor, or a proximity sensor. In some embodiments, the vision sensor 105 may be any device having an array of sensing devices (e.g., pixels) capable of detecting radiation in an ultraviolet wavelength band, a visible light wavelength band, or an infrared wavelength band. The vision sensor 105 may have any resolution. In some embodiments, the vision sensor 105 may be an omni-directional camera, or a panoramic camera. The vision sensor 105 may be any device capable of outputting a proximity signal indicative of a proximity of one of the objects 106 to a neighbor object 106. In some embodiments, the vision sensor 105 includes a laser scanner, a capacitive displacement sensor, a Doppler effect sensor, an eddy-current sensor, an ultrasonic sensor, a magnetic sensor, an internal sensor, a radar sensor, a LIDAR (Light Detection and Ranging) sensor, a sonar sensor, or the like. In some embodiments, the vision sensor 105 may be a temperature sensor operable detecting the temperature distribution of the objects 106. The vision sensor 105 may be any device capable of outputting a temperature signal indicative of a temperature sensed by the vision sensor 105. In some embodiments, the vision sensor 105 may include a thermocouple, a resistive temperature device, an infrared sensor, a bimetallic device, a change of state sensor, a thermometer, a silicon diode sensor, or the like.

In some embodiments, the vision sensor 105 capable of sensing depth is disposed within the cavity 104. The vision sensor 105 may have a field of view 132 directed through the objects 106, and toward an inner surface of the deformable surface 103. In some embodiments, the field of view 132 of the vision sensor 105 may be 62° x 45° +/– 10%. In some embodiments, the vision sensor 105 may be an optical sensor. As described in more detail below, the vision sensor 105 is capable of detecting the positions and movements of the objects 106. The vision sensor 105 may further be capable of detecting deflections of the deformable surface 103 when the deformable surface 103 comes into contact with an object. In one example, the vision sensor 105 is a time-of-flight sensor capable of measuring depth (i.e., a depth sensor). The time-of-flight sensor emits an optical signal (e.g., an infrared signal) and has individual detectors (i.e., “pixels”) that detect how long it takes for the reflected signal to return to the sensor. The time-of-flight sensor may have any desired resolution. The greater the number of pixels, the greater the resolution. The resolution of the sensor disposed within the vision sensor 105 may be changed. In some cases, low resolution (e.g., one “pixel” that simply detects displacement) may be desired. In others, a sensitive time-of-flight sensor may be used as a high-resolution vision sensor 105 that provides dense tactile sensing. Thus, the vision sensor 105 may be modular because the sensors may be changed depending on the application. A non-limiting example of a time-of-flight sensor is the Pico Flexx sold by PMD Technologies AG of Siegen, Germany. Other types of visual internal sensors include, by way of non-limiting example, stereo cameras, laser range sensors, structured light sensors/3D scanners, single cameras (such as with dots or other patterns inside), or any other suitable type of visual detector. For example, the vision sensor 105 may be configured as a stereo-camera capable of detecting deflections of the deformable surface 103 by an object.

In some embodiments, the touch sensitivity of the deformation sensor assembly 100 may be determined as a function of the resolution of the internal sensors within the deformation sensor assembly 100. For example, the resolution of a deformation sensor assembly 100 may be increased due to an increase in the resolution of the vision sensor 105 and/or the quantity of vision sensor 105. For example, a decrease in the number of vision sensor 105 within a deformation sensor assembly 100 can be compensated for by a corresponding increase in the resolution of at least some of the remaining vision sensor 105. As discussed in more detail below, the aggregate deformation resolution may be measured as a function of the deformation resolution or touch sensitivity among the deformation sensor assembly 100. In some embodiments, aggregate deformation resolution may be based upon a quantity of deformable sensors and a deformation resolution obtained from each deformable sensor in that portion.

In some embodiments, the vision sensor 105 includes one or more internal pressure sensors (barometers, pressure sensors, etc., or any combination thereof) utilized to detect the general deformation of the deformable surface 103 through the objects 106 in the cavity 104. In some embodiments, the vision sensor 105 may receive/send various data, such as through a conduit, wireless data transmission (Wi-Fi, Bluetooth, etc.), or any other suitable data communication protocol. For example, pressure within the cavity 104 may be specified by a pressurization parameter and may be inversely proportional to the deformability of the deformable surface 103 of the deformation sensor assembly 100. In some embodiments, the deformability of the deformable surface 103 of the deformation sensor assembly 100 may be modified by changing pressure within the cavity 104 or a material of the deformable surface 103 and/or the objects 106. In some embodiments, receipt of an updated parameter value may result in a real-time or delayed update (pressurization, etc.).

Still referring to FIG. 1, the light source 152 may be any device capable of outputting light, such as, but not limited to, a light-emitting diode, an incandescent light, a fluorescent light, or the like. In some embodiments, the light source 152 is attached to the bottom, top, side, or anywhere within the cavity 104 to illuminate the objects 106. The light source 152 may emit lights that travel through the objects 106 in the cavity 104, and further be detected by the vision sensor 105. When the objects 106 are colored, wavelengths of the emitted light may be altered by the objects 106 based on the color of the objects 106, and thus the detected light by the vision sensor 105 regarding the positions of the objects may reflect the color distribution of the objects 106 simultaneously with the movements of the objects 106 and/or with the deformation/displacement of the deformable surface 103. In some embodiments, when the light source 152 is included in deformation sensor assembly 100, the deformable surface 103 and/or one of the opposing end surfaces 102 may be opaque to external lights such that the detected light by the vision sensor 105 is based on the emitted light of the light source 152.

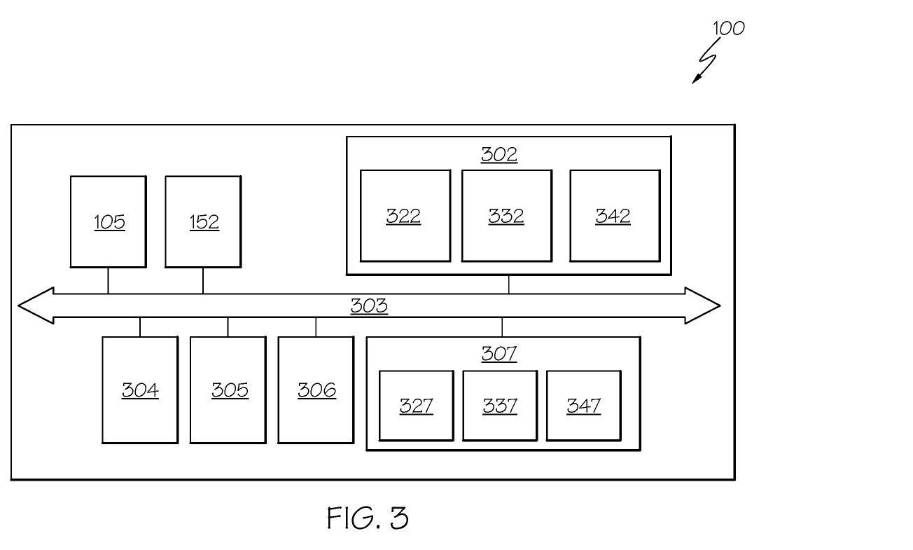

In some embodiments, in operation, the vision sensor 105 may capture the positions, the size, the shape, and the color of the objects 106 in their original positions when the deformable surface 103 is not deformed due to external force, such as grasping of the user. The vision sensor 105 may continue to monitor the movements, and distributions of the one or more characteristics of the objects, such as, without limitation, the body size, the body shape, and the body color of the objects 106. The movements and distributions of the characteristics of the objects 106 may correlate with the nature and extent of deformation of the deformable surface 103. For example, the vision sensor 105 may capture a blending color of the objects 106 after the light travels through various objects 106 in different body colors such that deformation sensor assembly 100 can track and infer the positions of the objects 106 not only the objects 106 closest to the vision sensor 105 but also the objects 106 further away or block by the closet objects 106. As such, the vision sensor 105 can capture the color blending information regarding the arrangement of the objects 106 and to understand the depth, distance, and relative position of the objects in a three-dimensional way. Similarly, the vision sensor 105 may capture a blending size and/or a blending shape of the objects 106 such that deformation sensor assembly 100 can track and infer the positions of the objects 106 not only the objects 106 closest to the vision sensor 105 but also the objects 106 further away or block by the closet objects 106. As such, the vision sensor 105 can capture the size blending and/or shape blending information regarding the arrangement of the objects 106 and to understand the depth, distance, and relative position of the objects in a three-dimensional way. In some embodiments, the deformation sensor assembly 100 includes a computing device (e.g., one or more processors 304 in FIG. 3) that includes one or more logics, such as operating logic 322, sensor logic 332 for receiving image data from one or more vision sensor 105, detection logic 342 for determination of the deformation of the deformable surface 103 and the movements and/or distribution of the objects 106. In operation, in some embodiments, when the deformable surface 103 comes into direct engagement with the user, such as the user’s hand, the deformable surface 103 may deform due to the external force from grasping and affects the configuration of the cavity 104. The objects 106 within the cavity 104 may move according to the shape and volume changes of the cavity 104. The vision sensor 105 controlled by the sensor logic 332 may capture the real-time movement and arrangement of the objects 106, in terms of their positions, connection patterns, and color distribution when more than one color objects are provided. The detection logic 342 may apply one or more models to determine the grasping pressure based on the data captured by the vision sensor 105, data captured by other sensors of the deformation sensor assembly 100, historical object position data 327, historical object property data 337, or a combination thereof.

In some embodiments, the detection logic 342 of the deformation sensor assembly 100 includes deformable surface modeling. The deformation surface modeling may be based on Finite Element Model (FEM) or Mass-Spring Model. Deformation sensor assembly 100 may simulate the deformable surface 103 using FEM to determine how it deforms under various external forces, such as grasping force, based on modeling of material properties of the deformable surface 103, such as elasticity and stiffness. Deformation sensor assembly 100 may use the mass-spring model to represent the deformable surface by representing each mass as a representing point on the surface and further including springs connecting these points to model elastic behavior.

In some embodiments, the detection logic 342 of the deformation sensor assembly 100 includes a cavity and body dynamics modeling. For the object dynamic modeling, deformation sensor assembly 100 may model the movement of the objects 106 inside the cavity 104 using physics-based simulations. As the deformable surface 103 deforms, the shape of the cavity 104 changes, causing the objects 106 to move. The dynamics of the objects 106 (position, velocity, and collisions) can be calculated based on the changing shape of the cavity 104. For the objects 106, deformation sensor assembly 100 may use a particle system modeling by treating the objects 106 as particles within a particle system model to simulate the motion and interaction of each object 106 as the cavity 104 deforms, including collisions with each other and with the cavity walls. The particle system modeling may use forces (such as gravity, contact forces, and friction) to determine the motion of each object 106. The detection logic 342 may include visual and sensory feedback modeling. The visual and sensory feedback modeling may be used to calibrate the vision sensor 105 to capture the position and movement of the objects 106 and further track the shape, position, movement, color, and/or connection patterns of the objects 106.

In some embodiments, the various logics, such as the operating logic 322, the sensor logic 332, and the detection logic 342, include one or more machine learning models, such as one or more neural networks. For example, a machine learning model may be included and trained to correlate the visual patterns observed (shapes, positions, and movements of the objects 106) with specific deformations of the deformable surface 103. The training may be based on a dataset of known deformations and corresponding object configurations. The one or more machine learning models may continue to be trained with the inputs of the vision sensor 105 and/or other sensors in deformation sensor assembly 100.

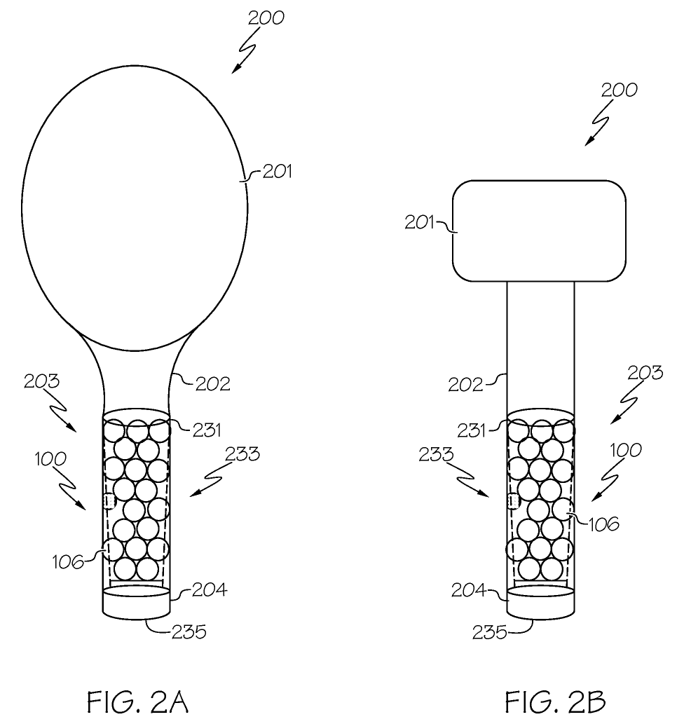

Referring now to FIGS. 2A and 2B, perspective views of example graspable assemblies, such as a sports gear item (FIG. 2A) and a mechanical tool (FIG. 2B) are illustrated. The graspable assembly 200 for grasping sensing may include an active portion 201, a grip portion 203, and a shaft portion 202. The deformation sensor assembly 100 may be embedded in the grip portion 203. The shaft portion 202 may mechanically connect the active portion 201 and the grip portion 203. The deformation sensor assembly 100 embedded grip portion 203 can be tailored to use in specific sports gear items or mechanical tools to engage the specific target to enhance its functionality and precision, enabling better interaction, feedback, or performance. For example, the graspable assembly 200 is a sports gear item as, without limitation, a tennis racket, a badminton racket, a golf club, or a baseball bat, or a mechanical tool as, without limitation, a hammer, a wrench, a screwdriver, or pliers, or any sports gear item or mechanical tool including a handle or graspable part. In some embodiment, the system includes the grip portion 203, without the active portion 201 and/or the shaft portion 202.

In some embodiments, the active portion 201 of the graspable assembly 200 is configured to interact directly with a target and perform a desired function of the sports gear item or mechanical tool. In some embodiments, the target is, without limitation, a tennis ball for a tennis racket, a badminton shuttlecock for a badminton racket, a golf ball for a golf club, a puck for an ice hockey stick, a fastener (e.g., a nail, screw, or bolt) for a hammer, or a mechanical part such as a nut or bolt for a wrench. In some embodiments, the active portion 201 includes durable and high-strength materials, such as, without limitation, metal (e.g., stainless steel, aluminum), and softer materials (e.g., rubber, silicone). In some embodiments, the active portion 201 includes a designed surface texture, such as the stringbed of a tennis racket. The shape and geometry of the active portion 201 may vary to fit the specific needs of the sport or tool. For example, the active portion 201 has an aerodynamic clubhead for a golf club, or adjustable jaws for a wrench to securely grip various fasteners.

In embodiments, the shaft portion 202 of the graspable assembly 200 is a connecting structure between the active portion 201 and the grip portion 203. The shaft portion may be made of lightweight, durable, and strong materials, such as, without limitation, carbon fiber, steel, and reinforced alloys. The length, diameter, and flexibility of the shaft portion 202 may vary depending on the intended use of the graspable assembly 200. For example, the shaft portion 202 of a tennis racket is relatively short and tapered to allow for flexibility and desired maneuvering. The shaft portion 202 of a wrench is longer and more rigid to provide leverage when turning fasteners.

In embodiments, the grip portion 203 of the graspable assembly 200 is a component for a user to hold and control the sports gear item or the mechanical tool of the graspable assembly 200. The deformation sensor assembly 100 is embedded in the graspable assembly 200 to provide tactile feedback regarding the interaction, such as grasping of the grip portion 203, to the user. In some embodiments, the grip portion 203 includes a first end 231, a second end 235, and a body 233 between the first end 231 and the second end 235. The grip portion 203 may be made of materials, such as, without limitation, wood, rubber, nylon, polypropylene, silicone, leather, steel, aluminum, titanium, carbon fiber, foam padding, or a combination thereof. The grip portion 203 may be contoured to fit within a person’s hand, providing natural support to reduce hand strain and fatigue during use. For example, the grip portion 203 includes bulges, indentations, or molded contours that align with the fingers and palm of a user.

In some embodiments, a stiffness of the grip portion 203 depends on the intended usage of the graspable assembly 200. For example, as a sports gear item, such as a tennis racket or a golf club, the grip portion 203 has a soft to moderate stiffness, such as, from about 100N/m to about 800 N/m, from about 200 N/m to about 700 N/m, from about 300N/m to about 600 N/m, from about 400N/m to about 500 N/m, or any value between 100N/m and 800 N/m. The grip portion, as a mechanical tool such as a hamper or a wrench, has a moderate to firm stiffness, such as, from about 500 N/m to about 1000 N/m, from about 600 N/m to about 900 N/m, from about 700 N/m to about 800 N/m, or any value between 500N/m and 1000 N/m. In some embodiments, a difference between a stiffness of the deformable surface 103 and a stiffness of a grip surface material for the graspable assembly 200 is below a deviation threshold. In some embodiments, the grip surface material is, without limitation, wood, rubber, nylon, polypropylene, silicone, leather, steel, aluminum, titanium, carbon fiber, foam padding, or a combination thereof. The deviation threshold may be about 1 N/m, about 2 N/m, about 3 N/m, about 5 N/m, about 10 N/m, about 20 N/m, about 50 N/m, about 100N/m, about 200N/m, about 500 N/m, or any value between 1 N/m and 500 N/m.

In some embodiments, the deformation sensor assembly 100 is, as illustrated in FIG. 2A and 2B, integrated with the grip portion 203. In some embodiments, the deformable surface 103 of the deformation sensor assembly 100 is exposed, and configured to interact with the user when the user grasps the grip portion 203. In some embodiments, the body 233 of the grip portion 203 includes a grasping surface 204. The grasping surface 204 may be made of, without limitation, wood, rubber, nylon, polypropylene, silicone, leather, steel, aluminum, titanium, carbon fiber, foam padding, or a combination thereof. The grasping surface 204 may be mechanically connected or coupled to the deformable surface 103 of the deformation sensor assembly 100. A difference between the stiffness of the deformable surface 103 and a stiffness of the grasping surface 204 is below a deviation threshold. The deviation threshold may be about 1 N/m, about 2 N/m, about 3 N/m, about 5 N/m, about 10 N/m, about 20 N/m, about 50 N/m, about 100 N/m, about 200 N/m, about 500 N/m, or any value between 1 N/m and 500 N/m.

In some embodiments, in operation, the disclosed apparatuses and systems using the graspable assembly 200 use the vision sensor 105 to monitor real-time positions of the objects 106 disposed within the cavity 104, which may change according to the deformation of the deformable surface 103. The disclosed apparatuses and systems may determine whether at least one of the plurality of objects is displaced based on the real-time positions of the objects 106 and determine a grasping pressure of the deformable surface 103 of the deformation sensor assembly 100 at least partially based on the displacement of the at least one of the plurality of objects 106. The disclosed apparatuses and systems may provide the grasping pressure to the user and may further use the grasping pressure information to provide feedback regarding the performance of the user of manipulation of the graspable assembly 200. The apparatuses and systems may provide whether the user has engaged with excessive or uneven pressure on the grip portion during manipulation and provide advice to adjust the grip strength to the user. The apparatuses and systems may also monitor whether prolonged or excessive pressure is used and provide a warning regarding potential fatigue or injury, such as hand, wrist, or arm strain. The apparatuses and systems may employ machine learning algorithms to continuously monitor the grasping pressure over time and track the user’s progress to identify patterns to provide personalized pieces of advice for the user.

Referring now to FIG. 3, components of an example deformation sensor assembly 100 described herein are schematically illustrated. In some embodiments, the deformation sensor assembly 100 includes a computing device in some embodiments.

The example deformation sensor assembly 100 provides a system for sensing deformation information of the deformation sensor assembly 100, and/or a non-transitory computer usable medium having computer readable program code for performing the deformation sensing and manipulation functions embodied as hardware, software, and/or firmware, according to embodiments shown and described herein. While in some embodiments, the computing device of the deformation sensor assembly 100 may be configured as a general-purpose computer with the requisite hardware, software, and/or firmware, in some embodiments, the computing device of the deformation sensor assembly 100 may be configured as a mobile phone, a vehicle, an electric appliance, and the like. It should be understood that the software, hardware, and/or firmware components depicted in FIG. 3 may also be provided in other computing devices external to the deformation sensor assembly 100 (e.g., data storage devices, remote server computing devices, and the like).

As also illustrated in FIG. 3, in some embodiments, the deformation sensor assembly 100 (or other additional computing devices) includes the vision sensor 105 for generating image data of the objects 106 within the housing 101 of the deformation sensor assembly 100, a light source 152 within the housing 101, a processor 304, input/output hardware 305, network interface hardware 306, a data storage component 307 (which may include historical object position data 327, historical object property data 337, and any other data 347 for performing the functionalities described herein), and a non-transitory memory component 302. The memory component 302 may be configured as a volatile and/or nonvolatile computer-readable medium and, as such, may include random access memory (including SRAM, DRAM, and/or other types of random access memory), flash memory, registers, compact discs (CD), digital versatile discs (DVD), and/or other types of storage components. Additionally, the memory component 302 may be configured to store operating logic 322, sensor logic 332 for receiving image data from one or more vision sensors 105, detection logic 342 for detecting a type of object and/or detecting a pose of an object based on historical object position data 327 and historical object property data 337 (each of which may be embodied as computer readable program code, firmware, or hardware, as an example). A local interface 303 is also included in FIG. 3 and may be implemented as a bus or other interface to facilitate communication among the components of the deformation sensor assembly 100.

The processor 304 may include any processing component configured to receive and execute computer-readable code instructions (such as from the data storage component 307 and/or memory component 302). The input/output hardware 305 may include an electronic display, keyboard, mouse, printer, camera, microphone, speaker, touch-screen, and/or other device for receiving, sending, and/or presenting data. The network interface hardware 306 may include any wired or wireless networking hardware, such as a modem, LAN port, wireless fidelity (Wi-Fi) card, WiMax card, mobile communications hardware, and/or other hardware for communicating with other networks and/or devices, such as to receive the data from various sources, for example.

It should be understood that the data storage component 307 may reside local to and/or remote from the deformation sensor assembly 100, and may be configured to store one or more pieces of data for access by the deformation sensor assembly 100 and/or other components. As illustrated in FIG. 3, the data storage component 307 may include the historical object position data 327 and the historical object property data 337, which in at least one embodiment includes image data generated by one or more vision sensors 105. The historical object position data 327 and the historical object property data 337 may be stored in one or more data storage devices. Historical object property data 337 may include, but is not limited to, historical color, shape, deformation, and other relevant physical and chemical properties of the objects 106. Other data 347 used to perform the functionalities described herein may also be stored in the data storage component 307. In some embodiments, the deformation sensor assembly 100 may be coupled to a remote server or other data storage device that stores the relevant data.

Included in the memory component 302 may be the operating logic 322, the sensor logic 332, and the detection logic 342. The operating logic 322 may include an operating system and/or other software for managing components of the deformation sensor assembly 100. The sensor logic 332 may reside in the memory component 302 and may be configured to receive and store image data from one or more vision sensors 105. The detection logic 342 may be configured to use data from a deformable sensor and/or one or more external image sensors to detect a type of object and/or a pose of an object. The operating logic 322, the sensor logic 332, and the detection logic 342 may be trained and provide machine learning capabilities via a neural network as described herein. By way of example, and not as a limitation, the neural network may utilize one or more artificial neural networks (ANNs). ANNs may include node inputs, one or more hidden activation layers, and node outputs, and may be utilized with activation functions in the one or more hidden activation layers. ANNs are trained by applying such activation functions to training data sets to determine an optimized solution from adjustable weights and biases applied to nodes within the hidden activation layers to generate one or more outputs as the optimized solution with a minimized error. Further, each of the various modules may include a generative artificial intelligence (AI) algorithm. The generative AI algorithm may include a general adversarial network (GAN) that has two or more networks including one or more generator neural networks and one or more discriminator neural networks. The generative AI algorithm may also be based on variation autoencoder (VAE) models or transformer-based models.

The light source 152 is coupled to the local interface 303 and communicatively coupled to the processor 304. The light source 152 may be any device capable of outputting light, such as, but not limited to, a light-emitting diode, an incandescent light, a fluorescent light, or the like. The vision sensor 105 is coupled to the local interface 303 and communicatively coupled to the processor 304. The vision sensor 105 may be a camera, a RGB sensor, a RGBD sensor, a time-of-flight sensor, or a proximity sensor.

The components as illustrated in FIG. 3 are merely examples and are not intended to limit the scope of this disclosure. More specifically, while the components in FIG. 3 are illustrated as residing within the deformation sensor assembly 100, this is a non-limiting example. In some embodiments, one or more of the components may reside external to the deformation sensor assembly 100.

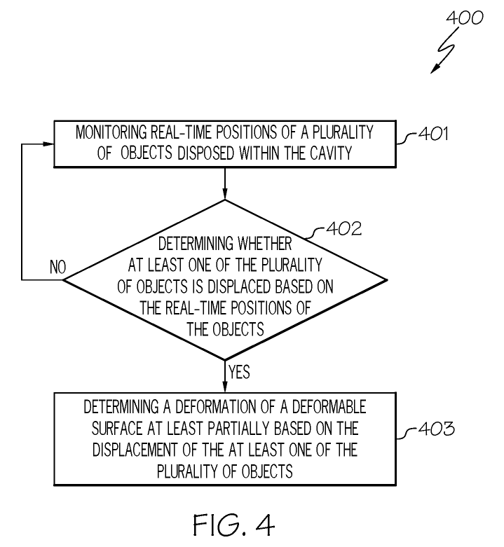

Turning now to FIG. 4, a flowchart illustrates an example method 400 to use the graspable apparatus and/or the graspable assembly for grasping sensing is illustrated. At block 401, the method 400 includes monitoring, using a vision sensor 105 (as in FIG. 1) arranged in a cavity 104 (as in FIG. 1) of a deformation sensor assembly 100 (as in FIG. 1), real-time positions of a plurality of objects 106 (as in FIG. 1) disposed within the cavity 104. At block 402, the method 400 includes determining whether at least one of the plurality of objects 106 is displaced based on the real-time positions of the objects 106. If the answer is yes, at block 403, the method 400 includes determining a grasping pressure of a deformable surface 103 (as in FIG. 1) of the deformation sensor assembly 100 at least partially based on the displacement of the at least one of the plurality of objects 106. The deformation sensor assembly 100 may be embedded in a grip portion 203 (as in FIGS. 2A and 2B) of the graspable assembly 200 (as in FIG. 2A and 2B). The deformation sensor assembly 100 may include a housing 101 (as in FIG. 1), the plurality of objects 106, and the vision sensor 105. The housing 101 may define the cavity 104 therein. The housing 101 may include the deformable surface 103 configured to be engaged with a user during grasping.

In some embodiments, the determining the grasping pressure of the method 400 may further include comparing the real-time positions of the objects 106 with grasping-free positions of the objects 106.

In some embodiments, the objects 106 may include two or more colors. The method 400 may further include monitoring a color distribution of the objects 106, and determining a change of the color distribution of the objects 106. The method 400 may further include in response to the change of color distribution of the objects 106, determining the grasping pressure based on the change of color distributions of the objects 106.

In some embodiments, a difference between a stiffness of the deformable surface and a stiffness of a grip surface material may be below a deviation threshold. The grip surface material may include, without limitation, wood, rubber, nylon, polypropylene, silicone, leather, steel, aluminum, titanium, carbon fiber, foam padding, or a combination thereof.

In some embodiments, the grip portion 203 may include a grasping surface 204. A difference between the stiffness of the deformable surface 103 and a stiffness of the grasping surface 204 may be below a deviation threshold. The grasping surface 204 may include, without limaition, wood, rubber, nylon, polypropylene, silicone, leather, steel, aluminum, titanium, carbon fiber, foam padding, or a combination thereof.

In some embodiments, the housing 101 may be in a cylindrical shape. The vision sensor 105 may be mechanically coupled to an inner surface of one cylindrical end. The objects 106 may include, without limitation, latex, silicone, acrylic, plastics, polycarbonate, opaque plastics with embedded particles, ceramics, or a combination thereof. The objects 106 may have, without limitation, a spherical shape, a rectangular prism shape, a hexagonal prism shape, a pyramid shape, or a combination thereof. The deformation sensor assembly 100 may further include a light source 152 (as in FIG. 1) within the cavity 104.

The preceding description is provided to enable any person skilled in the art to practice the various embodiments described herein. The examples discussed herein are not limited to the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A graspable apparatus for grasping sensing comprising:
a grip portion comprising a first end, a second end, and a body between the first end and the second end; and
a deformation sensor assembly embedded in the body, the deformation sensor assembly comprising:
a housing defining a cavity therein, the housing comprising a deformable surface configured to be engaged with a user during grasping,
a plurality of objects disposed within the cavity, and
a vision sensor arranged in the cavity, the vision sensor operable to monitor real-time positions of the plurality of objects.

2. The graspable apparatus of claim 1, wherein the body of the grip portion comprises a grasping surface, and a difference between a stiffness of the deformable surface and a stiffness of the grasping surface is below a deviation threshold.

3. The graspable apparatus of claim 1, wherein the deformation sensor assembly is configured to determine a grasping pressure applied to the grip portion based on a displacement of at least one of the plurality of objects.

4. The graspable apparatus of claim 1, wherein a stiffness of the deformable surface is configured to be adjusted by changing air pressure within the housing of the deformation sensor assembly.

5. The graspable apparatus of claim 1, wherein:
a difference between a stiffness of the deformable surface and a stiffness of a grip surface material is below a deviation threshold, and
the grip surface material comprises wood, rubber, nylon, polypropylene, silicone, leather, steel, aluminum, titanium, carbon fiber, foam padding, or a combination thereof.

6. The graspable apparatus of claim 1, wherein the plurality of objects are configured to move according to a deformation of the deformable surface in a synchronized manner.

7. The graspable apparatus of claim 1, wherein:
the housing is in a cylindrical shape; and
the vision sensor is mechanically coupled to an inner surface of one cylindrical end of the housing.

8. The graspable apparatus of claim 1, wherein:
the plurality of objects comprises two or more colors; and
the vision sensor is configured to capture a color distribution of the plurality of objects for grasping pressure determination.

9. The graspable apparatus of claim 1, wherein the deformation sensor assembly further comprises a light source within the cavity.

10. A graspable assembly for grasping sensing comprising:
an active portion configured to interact with a target;
a grip portion comprising a first end, a second end, and a body between the first end and the second end;
a shaft portion mechanically connecting the active portion and the grip portion; and
a deformation sensor assembly embedded in the body, the deformation sensor assembly comprising:
a housing defining a cavity therein, the housing comprising a deformable surface configured to be engaged with a user during grasping,
a plurality of objects disposed within the cavity, and
a vision sensor arranged in the cavity, the vision sensor operable to monitor real-time positions of the plurality of objects.

11. The graspable assembly of claim 10, wherein the body of the grip portion comprises a grasping surface, and a difference between a stiffness of the deformable surface and a stiffness of the grasping surface is below a deviation threshold.

12. The graspable assembly of claim 10, wherein the deformation sensor assembly is configured to determine a grasping pressure applied to the grip portion based on a displacement of at least one of the plurality of objects.

13. The graspable assembly of claim 10, wherein a stiffness of the deformable surface is configured to be adjusted by changing air pressure within the housing.

14. The graspable assembly of claim 10, wherein:
the plurality of objects comprises two or more colors; and
the vision sensor is configured to capture a color distribution of the plurality of objects for grasping pressure determination.

15. The graspable assembly of claim 10, wherein:
a difference between a stiffness of the deformable surface and a stiffness of a grip surface material is below a deviation threshold; and
the grip surface material comprises wood, rubber, nylon, polypropylene, silicone, leather, steel, aluminum, titanium, carbon fiber, foam padding, or a combination thereof.

16. The graspable assembly of claim 10, wherein the target is a ball, a puck, a fastener, a mechanical part, or a combination thereof.

17. A method to use a graspable apparatus for grasping sensing comprising:
monitoring, using a vision sensor arranged in a cavity of a deformation sensor assembly, real-time positions of a plurality of objects disposed within the cavity;
determining whether at least one of the plurality of objects is displaced based on the real-time positions of the plurality of objects;
in response to determining that the at least one of the plurality of objects is displaced, determining a grasping pressure of a deformable surface of the deformation sensor assembly at least partially based on a displacement of the at least one of the plurality of objects, wherein:
the deformation sensor assembly is embedded in a grip portion of the graspable apparatus, the deformation sensor assembly comprising a housing, the plurality of objects, and the vision sensor, and
the housing defines the cavity therein, the housing comprising the deformable surface configured to be engaged with a user during grasping.

18. The method of claim 17, wherein the grip portion comprises a grasping surface, and a difference between a stiffness of the deformable surface and a stiffness of the grasping surface is below a deviation threshold.

19. The method of claim 17, wherein the determining the grasping pressure further comprises comparing the real-time positions of the plurality of objects with grasping-free positions of the plurality of objects.

20. The method of claim 17, wherein:
a difference between a stiffness of the deformable surface and a stiffness of a grip surface material is below a deviation threshold; and
the grip surface material comprises wood, rubber, nylon, polypropylene, silicone, leather, steel, aluminum, titanium, carbon fiber, foam padding, or a combination thereof.
